(19) United States
(12) Patent Application Publication
(10) Pub. No.: US 2016/0303527 A1
(43) Pub. Date: Oct. 20, 2016

(54) Fluid Mixing Device

(71) Applicant: Western Energy Support and Technology, Inc., Cheyenne, WY (US)

(72) Inventor: Casey Hodges, Thornton, CO (US)

(73) Assignee: WESTERN ENERGY SUPPORT AND TECHNOLOGY, INC., Cheyenne, WY (US)

(21) Appl. No.: 14/689,026

(22) Filed: Apr. 16, 2015

(51) Int. Cl. B01F 5/06; G01F 1/34; G01F 1/684

(52) U.S. Cl. CPC B01F 5/0608; G01F 1/684; G01F 1/34

(57) ABSTRACT

A fluid mixing device includes a mixing element and a pathway for collecting a sample of fluid with an inlet end at a point where the fluid is well mixed. In an example embodiment, the pathway is provided through a body of the mixing element.

### TECHNICAL FIELD

The present disclosure relates to a fluid mixing device, and in particular a device for mixing and sampling fluid that is flowing through a conduit.

### BACKGROUND

Many industrial applications involve the flow of fluid through conduits. The term “fluid” as used herein refers to a liquids, gases, other media, or combinations thereof. It is important to measure characteristics of the fluid flow and for this reason various flow meter devices have been proposed which measure the fluid's mass flow rate and/or volume flow rate.

Another important characteristic for industry is the composition of the fluid that is flowing through a conduit. Depending on the specific context, flow may be multi-phase whereby it comprises two or more different states of matter, and/or multi-component where it comprises two or more components of the same state of matter.

It is important to measure fluid composition to ensure that it matches what is expected, or to have a quantitative measure for quality control or for value assessment considerations. For example, in the field of hydrocarbon extraction it is important to measure the “water cut”, that is, the ratio of water to hydrocarbons in a fluid flowing through a pipe. This value, in combination with a mass or volume flow rate reading for the entire flow, enables a determination to be made of the actual mass or volume of hydrocarbon that is present in the flow to make sure that the economic value of the flow can be reliably determined.

Determination of fluid flow composition is of importance in various other industries including without limitation water treatment, power plants, chemical, paper or metal production, food and beverage industries, and pharmaceutical industries. The present disclosure can be applied in these and other industries, and also in non-industrial contexts.

In order to properly determine fluid parameters, a properly representative sample of the fluid or fluids must be obtained. The sample is then used to determine the ratios of different phases or components of fluid in the combined stream, as well as properties of the fluids such as density and viscosity amount of entrained solids and so on.

In most cases different fluid phases or components will be immiscible, and in that scenario fluid is considered to be well mixed if it is sufficiently homogenised. To use the example of oil and water, a fluid flow comprising oil and water will be considered well mixed when the oil is broken into many fine droplets which are evenly dispersed throughout a sampled volume of water.

Traditional methods of collecting samples include collecting static samples from before the fluid is moved through the conduit, or utilising a static mixer with a separate sample probe.

Collecting a static sample requires the operator to possibly expose themselves and the environment to harmful chemicals. The static sample may also not be representative of the fluids that are actually being transported through the conduit.

Traditional static mixers tend to require a relatively long overall length in order to perform the mixing properly. Additionally, traditional static mixers provide no means for measurement of temperature or for other fluid flow parameters.

It is therefore an object of present disclosure to provide improved methods for sampling fluid flows that overcome or at least mitigate one or more of the above problems.

### SUMMARY

According to a first aspect of the disclosure there is provided a fluid mixing device for mixing fluid flowing through a conduit comprising a mixing member arranged to cause mixing of fluid between a central portion and a peripheral portion of a fluid conduit, and a pathway for collecting a sample of fluid flowing through the conduit comprising an inlet end at a point where the fluid is well mixed.

Optionally, the pathway is coupled with a sampling port is provided through a wall of the conduit.

Optionally, the mixing member is provided at a central portion of a fluid conduit.

Optionally, the fluid mixing device comprises a support member arranged to hold the fluid mixing device in place at the central portion of the fluid conduit.

Optionally, the pathway is formed through a body of the mixing member.

Optionally, the pathway is formed through a body of the mixing member and the support member.

Optionally, the fluid mixing device comprises a dedicated sampling member through which the pathway is formed.

Optionally, the mixing member has a body shaped to radially accelerate fluid flow at one of the central portion and the peripheral portion of the fluid conduit to be mixed with fluid from the other of the central portion and the peripheral portion of the fluid conduit.

In the case of a mixing member having a body provided at a central portion of the fluid conduit, the body will accelerate fluid flow at the central portion so that fluid from the central portion is mixed with fluid from a peripheral portion. On the other hand, in the case of a mixing member comprising an orifice plate or other peripheral obstruction, the body will accelerate fluid flow at the peripheral portion so that fluid from the peripheral portion is mixed with fluid from a central portion.

Optionally, the mixing member has a body shaped so that the fluid is well mixed downstream of the mixing member.

Optionally, the body of the mixing member comprises two frusto-conical portions conjoined at their larger ends.

Optionally, the body of the mixing member comprises an orifice plate.

Optionally the mixing device comprises a temperature sensing port.

Optionally the mixing device comprises a first pressure tap upstream of the mixing member and a second pressure tap downstream of the mixing member.

Optionally, the mixing device comprises a third pressure tap downstream of the mixing member.

According to a second aspect of the disclosure there is provided a conduit for containing fluid flow and comprising a fluid mixing device for mixing fluid flowing through a conduit comprising a mixing member arranged to cause mixing of fluid between a central portion and a peripheral portion of a fluid conduit, and a pathway for collecting a sample of fluid flowing through the conduit comprising an inlet end at a point where the fluid is well mixed.

The conduit and/or its mixing device may be provided with any of the features mentioned for the first aspect of the disclosure.

Optionally, the conduit comprises connections that allow the conduit to be connected to an adjoining conduit.

### BRIEF DESCRIPTION OF THE DRAWINGS

The disclosure will now be described, by way of example only, with reference to the accompanying drawings in which:

FIG. 1 shows a fluid mixing device according to a first embodiment of the disclosure;

FIG. 2 shows a cross-sectional view taken along line A-A of FIG. 1;

FIG. 3 shows a cross-sectional view taken along line B-B of FIG. 1;

FIG. 4 shows aspects of the fluid flow within the fluid mixing device of FIG. 1;

FIG. 5 shows a fluid mixing device according to a second embodiment of the disclosure, provided with a temperature sampling port;

FIG. 6 shows a fluid mixing device according to a third embodiment of the disclosure, provided with differential pressure measurement ports and a temperature sampling port;

FIG. 7 shows a mixing device according to the present disclosure, provided in situ with a fluid sampling and measurement system and conjoined with an adjacent fluid conduit;

FIG. 8 shows a fluid mixing device according to a further embodiment of the disclosure, in which a dedicated sampling member is provided; and

FIG. 9 shows a fluid mixing device according to a further embodiment of the disclosure, in which a mixing element comprises an orifice plate body.

### DETAILED DESCRIPTION

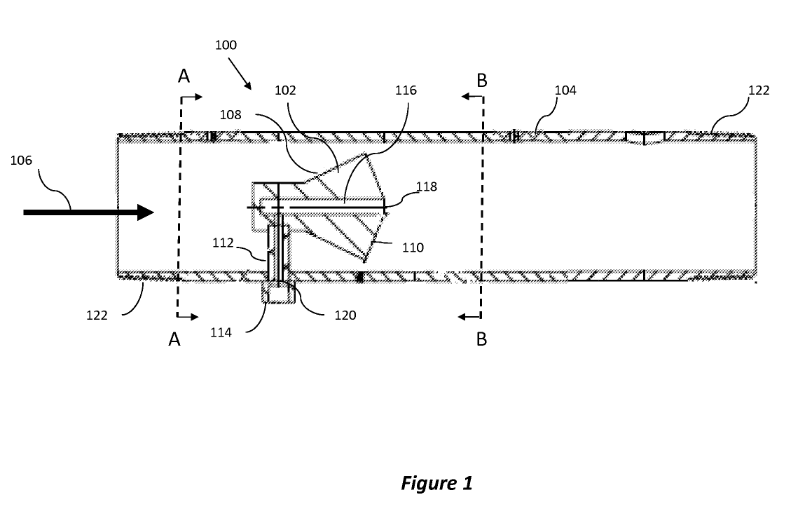

An example embodiment of a fluid mixing device 100 is shown in FIG. 1. The device comprises a mixing member 102 which is placed within a fluid conduit 104. Fluid flows along the conduit 104 from left to right in the diagram along the direction of the arrow 106. In this embodiment, the mixing member 102 is known as a cone type element and has a body comprising two frusto-conical portions 108, 110 conjoined at their larger ends. The mixing member 102 is held in position by a support member 112 which terminates at a sample port 114. A pathway 116 is formed within the body of the mixing member 102 and has a first inlet end 118 located at a central portion of the mixing member 102 and a second outlet end 120 located at the sample port 114.

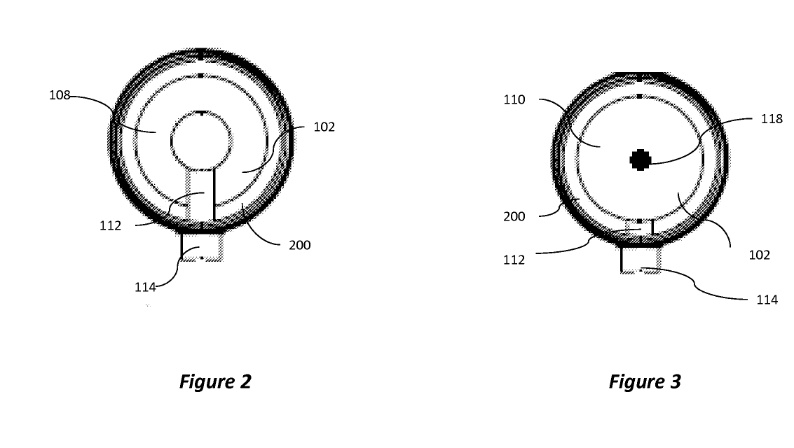

FIG. 2 shows a view through cross-section A-A of FIG. 1, looking towards an upstream end of the mixing member 102. The frusto-conical surface 108 causes fluid to be constricted within an annulus 200, accelerating the flow radially in the center region of the conduit 104 and mixing it with the flow at the perimeter, the combined flow being accelerated longitudinally through the annular region 200. FIG. 2 also shows the support structure 112 and sample tap 114.

FIG. 3 shows a view through cross-section B-B of FIG. 1, looking towards a downstream end of the mixing member 102. Here the second frusto-conical portion 110 is shown terminating in the first end 118 of the pathway 116. The support structure 112 and sample tap 114 are also shown.

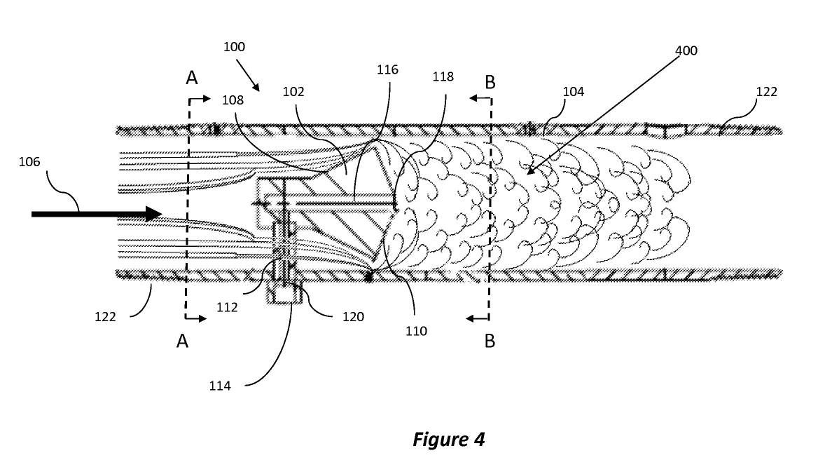

The mixing member 102 causes fluid in the center of the flowing stream to accelerate radially, and causes it to mix with the fluid flowing along the perimeter of the conduit 104. The effect of the mixing member 102 on fluid flow is shown in FIG. 4. Upstream of the mixing element 102 fluid is diverted from a central region towards a peripheral region, and downstream of the mixing element 102 there is a region 400 in which fluid is mixed, indicated by the swirls in the figure. Fluid dynamics dictates that the mixing member 102 causes a pressure drop from upstream of the mixing member 102 to downstream of the mixing member 102. This pressure drop creates a low pressure zone on the downstream side of the mixing member 102. The low pressure causes the mixed fluid to recirculate back to the center of the conduit 104, enhancing the mixing that has already been performed.

Therefore, there is a region downstream of the mixing element 102 in which the fluid is well mixed. This region provides a suitable volume from which a sample can be taken for the assessment of the fluid composition, and will extend for several pipe diameters downstream of the edge of the mixing device. A pathway can be provided having a first end at any point within the region of good mixing, and a second end coupled with a sampling port. However, if the first end is placed close to the edge of the mixing device this helps minimise the length of the sampling assembly. It has been found that a well-mixed sample can be taken from a point immediately downstream from the mixing member 102, in this case at the center of the conduit 104. The pathway 118 through both the mixing member 102 and the support 112 of the mixing member 102 allows the mixed fluid to be sampled directly from the downstream side of the mixing member 102.

Any suitable means may be provided for fixing the fluid obstruction member in the center portion of the fluid conduit 104. Typically this will be in the form of a single support member 112 which may be connected to the conduit 104 and the mixing member 102 in any manner including without limitation by welding, a threaded connection or by adhesive means.

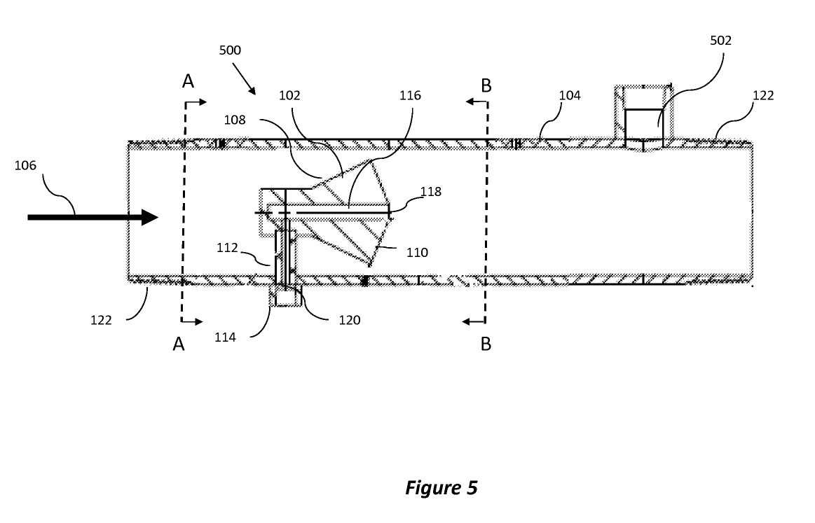

FIG. 5 shows a second embodiment of a fluid mixing device 500, which includes an integrated temperature sensing port 502. Remaining components of the fluid mixing device 500 are similar to those illustrated in FIGS. 1 to 4 and so have been illustrated using the same reference numerals, and operate as discussed above.

Determining the temperature of the flowing fluid is necessary in many cases for the calculation of fluid mass flow rate or fluid volume flow rate delivered through the conduit. By integrating a location for the measurement of the flowing temperature, the present disclosure combines two existing technologies into one common device with a shorter overall length than exists currently.

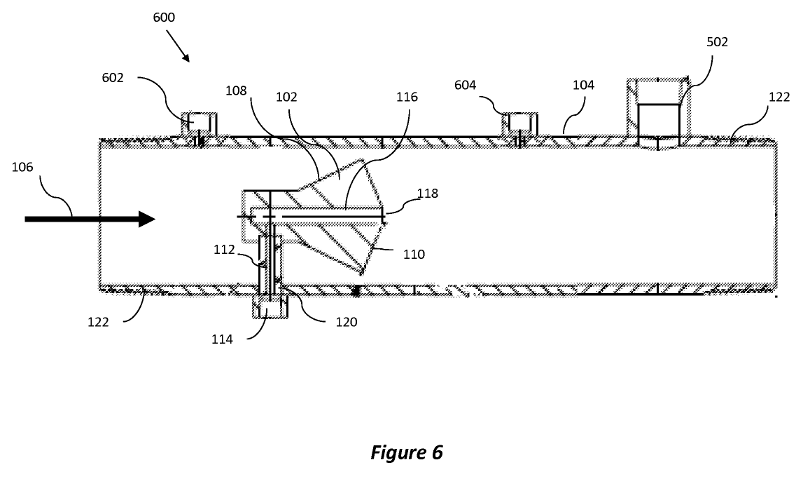

FIG. 6 shows a third embodiment of a fluid mixing device 600 which includes a first pressure tap 602 upstream of the mixing member 102 and a second pressure tap 604 downstream of the mixing member 102. Remaining components of the fluid mixing device 600 are similar to those illustrated in FIGS. 1 to 5 and so have been illustrated using the same reference numerals, and operate as discussed above.

A pressure measuring device may be coupled with the pressure taps 602, 604 to measure a differential pressure drop caused by the mixing member 102. Conservation of energy and conservation of mass dictate that the mixing member 102 will cause a pressure drop in the conduit 104 under flowing conditions. This pressure drop will correlate to the mass flow rate through the conduit. The mechanics of this relationship are well understood in general, but are specific to the device creating pressure drop. In this illustrated embodiment the device causing the pressure drop is a cone shaped mixing member 102. The present disclosure provides a novel differential pressure meter that can also be used to sample the fluid via the pathway as described above.

In a further modification, a third pressure tap can be provided downstream of the mixing element, in addition to the first and second pressure taps which are illustrated and preferably at a different longitudinal conduit position as compared with the other taps. This additional pressure tap allows for differential pressures to be measured between additional fluid conduit positions which can provide diagnostic information about the performance of the meter.

The specific embodiment illustrated in FIG. 6 also includes a temperature sensing port 502 as illustrated in FIG. 5. The combination of sampling, differential pressure measurement and temperature reading within a single integrated unit having a relatively short form factor is of great utility to the industry. It will of course be appreciated that pressure taps may be provided without the temperature port, and vice versa.

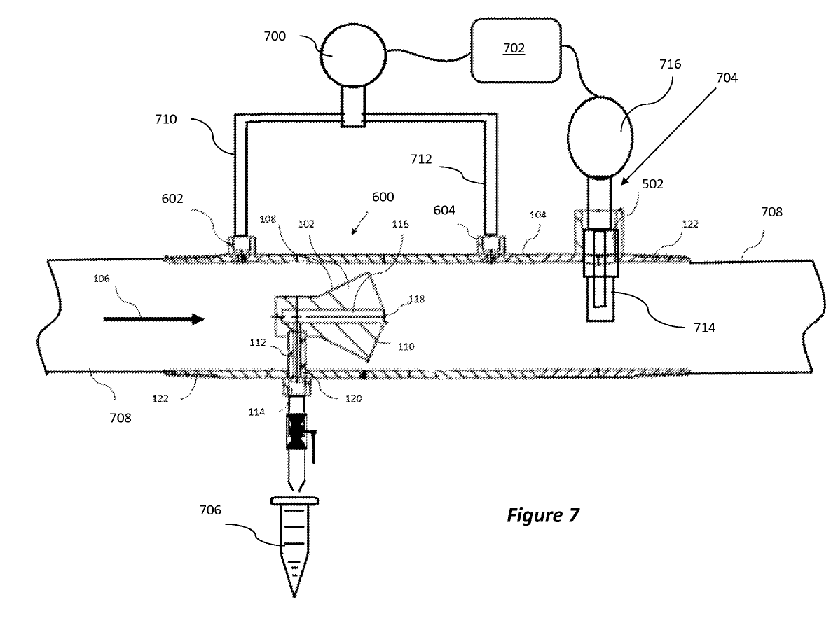

FIG. 7 illustrates an assembled fluid metering system that includes the mixing device 600 of FIG. 6. A differential pressure (DP) transmitter 700 is coupled between pressure taps 602 and 604 via a high pressure line 710 and a low pressure line 712 and measures the pressure difference between the taps. The output of the DP transmitter 700 is provided to a flow computer 702 which logs and analyses the readings of the DP transmitter 700.

A temperature sensing device 704 is coupled with the temperature sensing port 502. In this embodiment the temperature sensing device 704 comprises a thermowell 714 inserted into the temperature port 502 and a temperature sensor 716. The temperature sensor 716 may be any suitable device such as a thermometer, resistance temperature detector, thermocouple or other device.

A sampling device 706 is coupled with the sample port 114 for extracting a sample of the fluid and analysing its content. Any appropriate sampling device may be used. The sampling device could be as simple as a valve that can be opened to pass fluid to a container in which the sample can be analysed. It could also be an automatic sampler that captures a sample on a periodic basis. The sample can be analysed in several ways depending on the type of sample. Samples may typically be analysed for a combination of the following: density, composition, sediment and water content, although it will be appreciated that this list is non-limiting and the disclosure can apply to the sampling of other parameters or materials.

Outputs from the temperature sensing device 604 and the sampling device 606 can also be fed to the flow computer 602 for the performance of various calculations to determine parameters such as a mass flow rate for the flowing fluid. Connections of these devices and of the DP meter 600 with the flow computer may be by any appropriate wired or wireless communications link, where a wireless communications link involves transmission of data through atmospheric space.

It is to be appreciated that two or more of a pressure sensor, differential pressure sensor, temperature sensor can be integrated into a single multivariable transmitter (MVT), or be provided as separate components. Also, flow calculations can be carried out by or at an MVT or by a separate flow computer. The person skilled in the art will realise that there are numerous different types of readout sensors and devices and combinations thereof which can be used to implement the present disclosure, and the embodiment of FIG. 7 is an example only.

The conduit 104 of the mixing device 600 is coupled with a fluid conduit 708, and will usually have the same diameter (although it may have a different diameter if desired). The mixing device 600 can be inserted within existing pipework. In this illustrated embodiment, the fluid conduit 104 of the mixing device 600 comprises threaded connections 122 for threadable engagement with a conjoining fluid conduit 708. However any appropriate conduit connection may be provided and may for example be threaded, flanged welded or any other industrial acceptable connection.

The present disclosure provides a pathway for collecting a sample of fluid flowing through the conduit and having an inlet end at a point where the fluid is well mixed. An outlet end of the pathway may be coupled with a sampling port provided at a surface wall of the conduit, or may be coupled directly with a sampling chamber or other sampling device provided outside of the fluid conduit. Sampling may also be carried out from within the body of the conduit and/or from within the body of the mixing device.

In the embodiments illustrated so far, the pathway is integrated within the body of the mixing element. This provides certain advantages, for example providing a compact overall form factor. However this is not essential to the disclosure and in alternative embodiments the pathway is not integrated within the body of the mixing element but is instead provided at a separate sampling location.

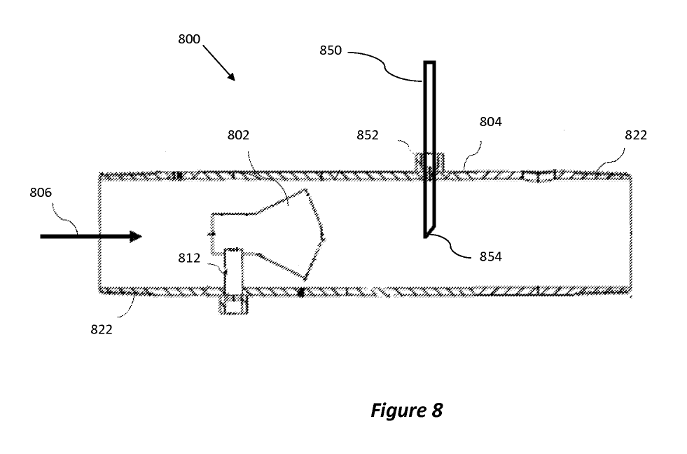

FIG. 8 shows a further embodiment of the fluid mixing device 800 according to the present disclosure, in which a hollow sample rod member 850 is provided passing through a sample port 852 provided downstream of a mixing element 802, which has a similar cone type form as that shown in FIG. 1. No internal pathway is provided for fluid sampling, but the physical mechanism of fluid mixing is similar. An inlet end 854 of the sampling rod 850 is provided at a point of the fluid conduit 804 where fluid flow is well mixed.

Note that while no fluid pathway is provided in the body of the mixing element for the purpose of sampling, it would be possible for a fluid pathway to be provided for other purposes, such as measuring pressure and determining flow rate.

The embodiment of FIG. 8 is basically a modification of the embodiment illustrated in FIG. 1. Fluid flows in a similar direction 806, and the couplings 822 and support member 812 function in a similar manner to their counterpart elements in FIG. 1. It is to be appreciated that additional temperature and differential pressure taps may be provided for the embodiment of FIG. 8 in a similar manner to that illustrated above. Also, the dedicated pathway concept may be applicable for other variations as contemplated herein including different types and shapes of mixing element. It will be appreciated that the mixing member 102, 802 may be replaced by a mixing member of various different forms. In general, the mixing member comprises a fluid obstruction member provided in the fluid flow and which causes mixing between a central portion and a peripheral portion of the fluid conduit, through radial deflection or acceleration of the fluids within the conduit.

For example, in an alternative embodiment, the mixing member may comprise a single frusto-conical element with a sharp edge, namely the second frusto-conical surface 110 in FIG. 1 may be replaced by a straight edge so that the mixing member forms a simple conical frustum. Other shapes are also possible including: fins on the cone, a cone attached to the wall at more than one point (for example, three or four points), a half oval (bullet) shape, a half-moon shape, or a horizontal or vertical flow/pipe arrangement.

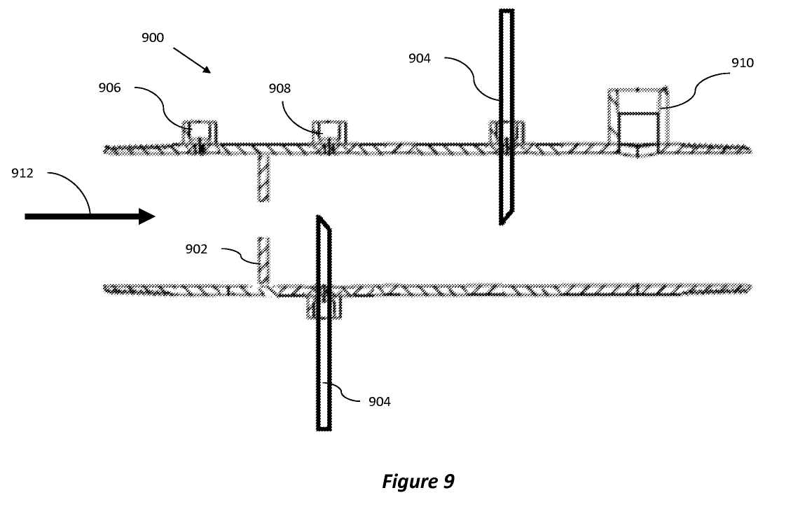

FIG. 9 illustrates a further embodiment of the disclosure showing a fluid mixing device 900 in which the mixing element provided in the form of an orifice plate 902. The orifice plate 902 provides an annular constriction to fluid flow and therefore mixes the fluid downstream of it with respect to the fluid flow 912. The fluid is sampled by a hollow sampling rod 904 provided at a downstream position of the orifice plate 902. The figure shows two possible locations for the sampling rod 904. In practice only one of them will normally be provided. The embodiment of FIG. 9 also provides pressure taps 906, 908 upstream and downstream respectively of the mixing element 902, and temperature port 910. Pressure sensing and temperature sensing devices, together with associated flow computers and sampling apparatus may be provided together with the embodiment of FIG. 9 in a similar manner as illustrated above.

Any type of orifice plate can be used, including without limitation concentric square edged, conditioning, multi-holed, torus wedge, quadrant edged.

It may also be possible for a sampling port to be integrated within the body of an orifice plate although this would be involving a larger figure type structures technical plate 30 provided.

The present disclosure therefore provides many advantages compared with existing mixing devices. An operator may collect a fluid sample of the actual transported fluid without requiring to be exposed to it. The present disclosure provides the ability to properly mix and sample the fluid and also optionally to determine the temperature of the fluid, and has a shorter overall length than traditional mixers. Additionally, the present disclosure provides mixing with a lower permanent pressure loss as compared with traditional static mixing devices.

Additionally the present disclosure may provide the ability to measure the flow rate of fluid using the conservation of mass and conservation of energy within the conduit. The disclosure improves upon existing technology by combining the flow rate measurements with fluid sampling and temperature determination into one single device.

Various improvements and modifications can be made to the above without departing from the spirit or scope of the present invention.

1. A fluid mixing device for mixing fluid flowing through a conduit comprising:
a mixing member arranged to cause mixing of fluid between a central portion and a peripheral portion of a fluid conduit, and
a pathway for collecting a sample of fluid flowing through the conduit comprising an inlet end at a point where the fluid is well mixed.

2. The fluid mixing device of claim 1, wherein the pathway is coupled with a sampling port provided through a wall of the conduit.

3. The fluid mixing device of claim 1, wherein the mixing member is provided at a central portion of a fluid conduit.

4. The fluid mixing device of claim 3, wherein the fluid mixing device comprises a support member arranged to hold the fluid mixing device in place at the central portion of the fluid conduit.

5. The fluid mixing device of claim 1, wherein the pathway is formed through a body of the mixing member.

6. The fluid mixing device of claim 4, wherein the pathway is formed through a body of the mixing member and the support member.

7. The fluid mixing device of claim 1, comprising a dedicated sampling member through which the pathway is formed.

8. The fluid mixing device of claim 1, wherein the mixing member has a body shaped to radially accelerate fluid flow at one of the central portion and the peripheral portion of the fluid conduit to be mixed with fluid from the other of the central portion and the peripheral portion of the fluid conduit.

9. The fluid mixing device of claim 1, wherein the mixing member has a body shaped so that the fluid is well mixed downstream of the mixing member.

10. The fluid mixing device of claim 1, wherein the body of the mixing member comprises two frusto-conical portions conjoined at their larger ends.

11. The fluid mixing device of claim 1, wherein the body of the mixing member comprises an orifice plate.

12. The fluid mixing device of claim 1, further comprising a temperature sensing port.

13. The fluid mixing device of claim 1, further comprising a first pressure tap upstream of the mixing member and a second pressure tap downstream of the mixing member.

14. The fluid mixing device of claim 13, further comprising a third pressure tap downstream of the mixing member.

15. A conduit for containing fluid flow and comprising a fluid mixing device for mixing fluid flowing through the conduit comprising a mixing member arranged to cause mixing of fluid between a central portion and a peripheral portion of the conduit, and a pathway for collecting a sample of fluid flowing through the conduit comprising an inlet end at a point where the fluid is well mixed.

16. The conduit of claim 15, comprising connections that allow the conduit to be connected to an adjoining conduit.
